(19) United States
(12) Patent Application Publication
(10) Pub. No.: US 2003/0189115 A1
(43) Pub. Date: Oct. 9, 2003

(54) Liquid ejection pump system

(75) Inventors: Evert Klaseboer, Singapore (SG); Cheng Wang, Singapore (SG); Kin Chew Hung, Singapore (SG); Boo Cheong Khoo, Singapore (SG)

Correspondence Address: HOGAN & HARTSON L.L.P., 500 S. GRAND AVENUE, SUITE 1900, LOS ANGELES, CA, 90071-2611, US

(73) Assignees: INSTITUTE OF HIGH PERFORMANCE COMPUTING; NATIONAL UNIVERSITY OF SINGAPORE

(21) Appl. No.: 10/230,645

(22) Filed: Aug. 29, 2002

(30) Foreign Application Priority Data
Apr. 8, 2002 (SG) 200202052-7

(51) Int. Cl. B05B 5/00

(52) U.S. Cl. 239/690

(57) ABSTRACT

The invention can be used in a micropump for dispensing a pharmaceutical liquid, in an ink jet printer or similar devices, or in other applications for controlled pumping of a liquid through an opening in a barrier wall. A pair of electrodes is in electrical contact with a fluid confined behind a containing wall. Each electrode is connected to a source of different electrical potential. When current is conducted through the fluid between the electrodes, resistance heating in the fluid causes local boiling and thus the formation and expansion of a bubble within the fluid. The electrodes are disposed on either side of an opening in the wall, so that the bubble is formed on one side of the wall in close proximity to the opening. Fluid behavior is such that a fluid jet is formed when the bubble collapses in close proximity to the wall. This jet impacts the bubble in a direction toward the wall. The jet then penetrates the bubble to impact against the wall and to urge a quantity of the fluid through the wall opening.

### BACKGROUND OF THE INVENTION

The invention relates generally to apparatus and methods for controlling the flow of fluids. More specifically, the invention provides novel apparatus and methods for pumping a fluid across an aperture formed in a wall enclosing the fluid. The invention may find use in a micropump such as might be used to dispense pharmaceuticals or other fluids, in ink jet printers or similar apparatus, or in other applications.

Many different pumps have been devised to transport a wide variety of liquids. Most such pumps include moving parts such as pistons and valves. These moving parts are problematic, though, and particularly in micropumps. Very small parts are difficult to fabricate and assemble, and vulnerable to wear and failure in use.

Micropumps with no moving parts have been proposed. Some of these use ultrasound and have capacities on the order of a few microliters per minute. Other proposals have been directed to pumps in which fluid flow occurs through the controlled formation of bubbles within the fluid, along with selective conveyance of the fluid, urged by the bubbles' expansion. In one such pump, the bubbles are created in the fluid through the selective application of heat created by the transmission of electrical current through the electrical resistance of the fluid.

Such pumps are very much in their early stage of development, though, and there is a distinct need for the development of new apparatus and methods for the controlled pumping of fluids, especially in micropumps, and particularly for applications such as the delivery of pharmaceutical agents. Such pumps be of simple construction with few or no moving parts. The pumps should be reliable in operation, and provide for precise flow control of fluid moving through the pump. These and other advantages are provided by the apparatus and methods described in this document. These and other features of the invention can be appreciated more fully by reference to this written description and the figures that accompany it.

### SUMMARY OF THE INVENTION

The invention provides methods and apparatus for pumping or urging quantities of fluid through an opening in a wall that confines the fluid. When a bubble in fluid collapses in close proximity to the surface of a wall, a fluid jet is formed and directed into the bubble in a direction toward wall. This jet will frequently, depending upon conditions in the fluid, penetrate through the bubble and impact on the opposite wall. If an opening is provided in the wall where the jet impacts the wall, then the force of the fluid jet will urge a quantity of the fluid through the opening and outside of the wall. This principle may find use, e.g., in micropumps for dispensing controlled doses of pharmaceuticals or other liquids with a high degree of control.

In one embodiment, a pair of electrodes is in electrical contact with the fluid, with each electrode connected to a source of different electrical potential. When current is conducted through the fluid between the electrodes, resistance heating in the fluid causes local boiling and thus the formation and expansion of a bubble within the fluid. Current flow between these electrodes may be controlled, e.g., by operation of a switch, or by other appropriate means. In this embodiment, the electrodes are disposed on either side of the opening, so that the bubble will be formed on one side of the wall in close proximity to the opening. When the bubble collapses, the resulting fluid jet will then urge a quantity of the fluid through the opening in the wall.

### BRIEF DESCRIPTION OF THE DRAWINGS

FIGS. 1a to 1i are sequential illustrations depicting the results of a numerical simulation illustrating the formation, expansion, and collapse of a bubble in a fluid in close proximity to the surface of a wall.

FIGS. 2a to 2d are sequential illustrations depicting the formation, expansion, and collapse of a bubble in a fluid in close proximity to an opening in the surface of a wall, which produces a liquid jet to urge a quantity of the fluid through the opening.

FIG. 3 is a semi-schematic illustration, in cross-section of apparatus for forming and expanding a bubble in a fluid in close proximity to an opening in the surface of a wall.

FIG. 4 depicts an embodiment in which multiple bubbles are formed and collapsed in proximity to multiple holes in a wall surface.

### DESCRIPTION OF THE PREFERRED EMBODIMENTS

The invention utilizes knowledge gained through the study and simulation of the formation and collapse of bubbles within a surrounding fluid. Bubbles expanding in a fluid typically have a very nearly spherical shape throughout their expansion. When the bubbles collapse, though, non-spherical shapes are frequently observed.

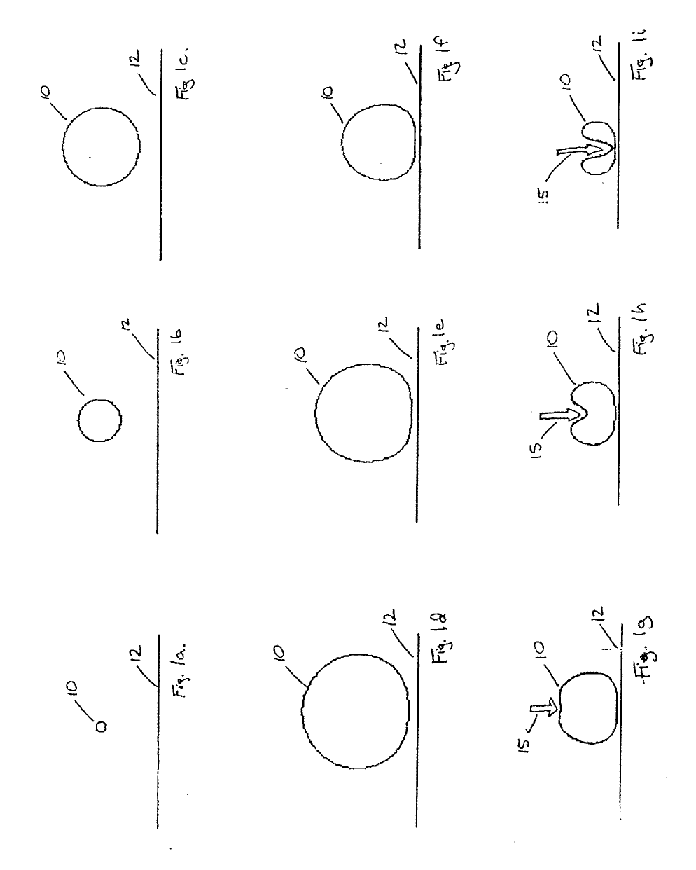

This invention is particularly concerned with the formation and collapse of bubbles near a solid wall. FIGS. 1a to 1i depict, in sequence, the results of a numerical simulation illustrating the formation and collapse of a bubble 10 in close proximity to such a wall 12. FIG. 1a shows the initial formation of the bubble. FIG. 1b shows the bubble expanded somewhat, FIG. 1c shows further expansion of the bubble, and FIG. 1d shows the bubble near the peak of its expansion. Note that in FIGS. 1a-1d, the shape of the bubble is very nearly spherical.

FIG. 1e shows the bubble 10 beginning to collapse. FIG. 1f shows the bubble collapsing further. As FIG. 1g indicates, and as can be seen still more clearly in FIG. 1h, the collapsing bubble becomes non-spherical, which leads to the formation of a high-velocity fluid jet 15 directed toward the wall 12 from the side of the bubble opposite the wall. As FIG. 1i illustrates, under appropriate conditions the jet will penetrate the bubble (thereby forming a toroidal bubble), and continue on to impact against the wall.

Jets of this type occur with bubbles of greatly varying size. Such effects have been observed in bubbles created in underwater explosions, in which the bubbles are on the order of about ten meters in diameter. The same effect has been observed in simulations of much smaller bubbles, e.g., bubble having diameters on the order of between one and ten millimeters. The physical behavior of the bubbles and fluid jets are generally similar for large and small bubbles. Differences in behavior for such cases arise mainly through the effects of surface tension within the particular fluid in which the bubbles are formed. These effects are observed both for bubbles of gas bubbles in liquid, and for bubbles filled with fluid vapor in the liquid fluid. The behavior of the jet may be influenced by the direction of the gravity vector operating on the fluid. For small bubbles, though, these gravity effects are generally very small, and may in fact be negligible in many applications.

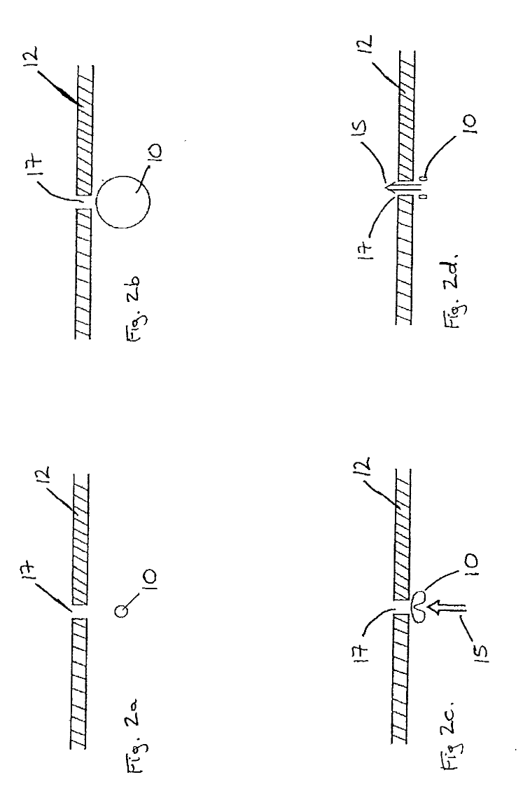

Apparatus may be configured to exploit this behavior for the transport of a fluid across the solid boundary of a wall. FIG. 2a illustrates the formation of a small bubble 10 in proximity to a solid wall 12. In this illustration though, a small opening or hole 17 is formed in the wall close to the bubble's formation site. This hole is small enough so that surface tension and viscosity in the fluid prevent leakage of the fluid through the hole under ordinary conditions so that fluid is thereby retained inside the wall. Small holes are advantageous for this reason. It should be noted, though, that the invention will work and may find use even with holes too large to retain fluid behind the wall purely by surface tension. Some applications may feature holes very much larger than those contemplated for use in this particular embodiment.

FIG. 2b shows the expanded bubble 10. FIG. 2c shows the bubble's collapse, and the liquid jet 15 impinging on the bubble opposite the opening in the wall. As FIG. 2d illustrates, motion of the jet towards and against the wall ejects a certain quantity of the fluid through the hole 17. The fluid may thus be ejected through the wall by ejection in response to a fluid jet created when a bubble is formed, expanded, and collapsed in the fluid in close proximity to the opening. By repeating and controlling these steps—bubble formation, expansion, and collapse—fluid can be carried or pumped through the wall in a controlled manner.

Bubbles can be formed in a fluid in a wide variety of ways. Bubbles may be generated in a fluid, e.g., by applying ultrasound to the fluid, by electric sparks created within the fluid, by heating the fluid to cause local boiling or vapor formation, by focusing a laser beam or another source of directed energy into the liquid to make the liquid boil, by ejecting a gas into the fluid, by explosion, or by any other suitable mechanism.

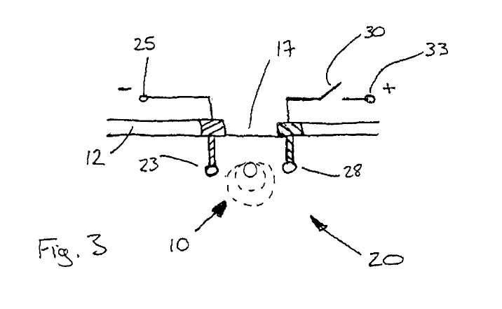

FIG. 3 illustrates one apparatus for creating and expanding a bubble near a hole through a container wall. FIG. 3 is a semi-schematic illustration of apparatus 20 for creating an electrical current flow in an electrically conductive fluid to form a bubble 10 near a hole 17 in a wall 12.

A first electrode 23 is provided within the fluid at a location near the wall 12 on one side of the hole 17. The first electrode is in electrical contact with the fluid and connected to a ground 25 or a source of negative electrical potential. A second electrode 28 is located within the fluid near the wall 12 on a side of the hole opposite the first electrode. The second electrode is also in electrical contact with the fluid, but is connected through a switch 30 to a positive potential source 33.

When the switch 30 is on, an electrical current flows through the electrically conductive fluid. Resistive heating in the fluid causes local boiling and the formation of a bubble 10 in the fluid at a site generally between the first electrode 23 and the second electrode 28 on either side of the hole 17. Each electrode is mounted on a post or another structure that locates the electrode at some small distance away from the wall. Ideally, the posts that support the electrodes should be electrically insulated so that current will flow through the fluid directly between the two electrodes. It should be noted that FIG. 3 is somewhat schematic in nature, and not necessarily to scale. The electrodes and posts should ideally be fairly small relative to the size of the bubble, so that the presence of these structures will not interfere unduly with the normal dynamics of the bubble's formation, expansion, and collapse.

Once formed, the bubble will continue to expand at the location of its formation near the hole. In the figure, the bubble's expansion is indicated by the broken lines surrounding the solid-line illustration of the bubble. When the bubble reaches its maximum size and then collapses, the resulting fluid jet forces a quantity of the fluid through the hole to the opposite side. By operating the switch appropriately, the flow of fluid through the hole can be controlled with great precision.

Apparatus of this type is advantageous in providing very precise control over the fluid flow. A pump of this type that relies on the formation and collapse of bubble in a fluid potential offers a very high response time, along with substantial flow rates achieved through the rapid formation and collapse of bubbles in the fluid. As an example, a complete process of formation, growth, collapse and jetting may take place in about 0.2 milliseconds for a bubble with a maximum radius of about one millimeter. Many bubbles can be produced and collapsed in a very short time, allowing a favorable combination of significant flow rates with very precise flow control.

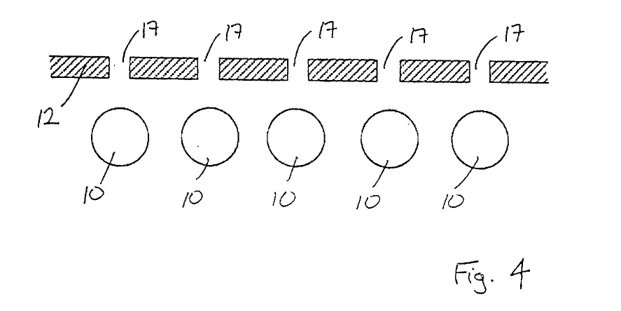

Higher flow rates can be achieved by multiplying the apparatus. FIG. 4 depicts an embodiment in which multiple bubbles 10 are formed, expand, and collapse near multiple holes 17 in a wall 12. In such an embodiment, each opening will generally be paired with its own apparatus for forming a bubble near the hole. Just as described above, each bubble's collapse will give rise to a liquid jet directed toward the hole, and this jet will drive a small amount of the fluid across the wall through that hole. The apparatus for forming the bubbles may use electrical resistance, as in the embodiment described above, or it may operate according to a different principle.

Exemplary embodiments of apparatus and methods for practicing the invention have been described above. The invention is not limited to these particular embodiments, though. Modifications, improvements, additions, and alternatives will no doubt be developed in the future by those of skill in the art. In particular alternative or improved means may be developed for controlling the formation and collapse of the bubbles within the fluid, and those future improvements are regarded as utilizing and being within the same inventive concept as the examples disclosed above. The proper scope of the invention should not be determined primarily by the foregoing examples. Instead, the true scope of the invention should be determined primarily by reference to the appended claims, along with the true scope of equivalents to which those claims are legally entitled.

What is claimed is:

1. A fluid pump comprising:
a wall having an opening therein, the wall configured to confine a fluid; and
bubble forming apparatus operable to form a bubble in the fluid near the opening in the wall;
wherein the opening is configured so that a collapse of the bubble forms a liquid jet that urges a quantity of the fluid through the opening in the wall.

2. The fluid pump of claim 1, wherein the bubble forming apparatus includes a source of electrical potential operable to conduct an electric current through the fluid.

3. The fluid pump of claim 2, wherein the bubble forming apparatus further includes a first electrode in electrical contact with the first source of electrical potential and the fluid, and wherein the first source of electrical potential is in electrical contact with the fluid through the first electrode.

4. The fluid pump of claim 3, wherein the bubble forming apparatus further comprises a second source of electrical potential different from that of the first source of electrical potential, and wherein the second source of electrical potential is in electrical contact with the fluid.

5. The fluid pump of claim 4, wherein the bubble forming apparatus further comprises a second electrode in electrical contact with the second source of electrical potential and the fluid, and wherein the second source of electrical potential is in electrical contact with the fluid through the second electrode.

6. The fluid pump of claim 5, wherein the bubble forming apparatus further comprises a switch between at least one of the first electrode and the second electrode and its corresponding source of electrical potential, and wherein the switch is operable to control the conduction of electrical current through the fluid.

7. A fluid pump comprising:
a wall having an opening therein, the wall configured to confine a fluid; and
means for forming a bubble in the fluid near the opening in the wall;
wherein the opening is configured so that a collapse of the bubble forms a liquid jet that urges a quantity of the fluid through the opening in the wall.

8. The fluid pump of claim 7, wherein the bubble forming means includes a source of electrical potential operable to conduct an electric current through the fluid.

9. The fluid pump of claim 8, wherein the bubble forming means further includes a first electrode in electrical contact with the first source of electrical potential and the fluid, and wherein the first source of electrical potential is in electrical contact with the fluid through the first electrode.

10. The fluid pump of claim 9, wherein the bubble forming means further comprises a second source of electrical potential different from that of the first source of electrical potential, and wherein the second source of electrical potential is in electrical contact with the fluid.

11. The fluid pump of claim 10, wherein the bubble forming means further comprises a second electrode in electrical contact with the second source of electrical potential and the fluid, and wherein the second source of electrical potential is in electrical contact with the fluid through the second electrode.

12. The fluid pump of claim 11, wherein the bubble forming means further comprises a switch between at least one of the first electrode and the second electrode and its corresponding source of electrical potential, and wherein the switch is operable to control the conduction of electrical current through the fluid.

13. A fluid pump comprising:
a wall having an opening therein, the wall configured to confine a fluid; and
a first source of electrical potential in electrical contact with the fluid;
wherein the source of electrical potential is operable to conduct an electric current through the fluid;
wherein the opening is configured so that the electric current flowing through the fluid expands a bubble in the fluid at a location near the opening; and
wherein the opening is configured so that a collapse of the expanded bubble forms a liquid jet that urges a quantity of the fluid through the opening in the wall.

14. The fluid pump of claim 13, and further comprising a first electrode in electrical contact with the first source of electrical potential and the fluid, wherein the first source of electrical potential is in electrical contact with the fluid through the first electrode.

15. The fluid pump of claim 14, and further comprising a second source of electrical potential different from that of the first source of electrical potential, wherein the second source of electrical potential is in electrical contact with the fluid.

16. The fluid pump of claim 15, and further comprising a second electrode in electrical contact with the second source of electrical potential and the fluid, wherein the second source of electrical potential is in electrical contact with the fluid through the second electrode.

17. The fluid pump of claim 16, and further comprising a switch between at least one of the first electrode and the second electrode and its corresponding source of electrical potential, wherein the switch is operable to control the conduction of electrical current through the fluid.

18. The fluid pump of claim 13, and further comprising a second source of electrical potential different from that of the first source of electrical potential, wherein the second source of electrical potential is in electrical contact with the fluid.

19. The fluid pump of claim 18, wherein the first source of electrical potential is in electrical contact with the second source of electrical potential through the fluid.

20. A fluid pump comprising:
a wall having an opening therein, the wall configured to confine a fluid;
a first source of electrical potential;
a first electrode, wherein the first source of electrical potential is in electrical contact with the fluid through the first electrode;
a second source of electrical potential different from that of the of the first source of electrical potential,
a second electrode, wherein the second source of electrical potential is in electrical contact with the fluid through the second electrode; and
a switch between at least one of the first and second electrode and its corresponding source of electrical potential;
wherein the switch is operable to control a flow of electrical current through the fluid between the first and second electrodes;
wherein the opening is configured so that the electric current flowing through the fluid expands a bubble in the fluid at a location near the opening; and
wherein the opening is configured so that a collapse of the expanded bubble forms a liquid jet that urges a quantity of the fluid through the opening in the wall.

21. A method for pumping fluid through a wall, the method comprising:
forming a bubble in the fluid near an opening in a solid wall;
collapsing the bubble, wherein the collapse of the bubble forms a fluid jet directed toward the wall; and
urging fluid through the opening by force applied by the fluid jet.

22. The method of claim 21, wherein forming the bubble includes conducting an electrical current through the fluid at the site of the bubble's formation.

23. The method of claim 22, wherein conducting an electrical current through the fluid at the site of the bubble's formation includes conducting the electrical current through two electrodes of different electrical potentials.

24. The method of claim 23, and further comprising controlling the application of electrical potential to at least one of the two electrodes.

25. The method of claim 24, wherein controlling the application of electrical potential to at least one of the two electrodes includes operating a switch.
